(19) United States
(12) Patent Application Publication
(10) Pub. No.: US 2025/0135648 A1
(43) Pub. Date: May 1, 2025

(54) AUTONOMOUS GLADHAND COUPLING SYSTEMS, DEVICES, AND METHODS

(71) Applicant: Robotic Research OpCo, LLC, Clarksburg, MD (US)

(72) Inventors: Alberto Daniel LACAZE, Potomac, MD (US); Steven ROTUNDO, Baltimore, MD (US); Ryan Matthew MOSS, Frederick, MD (US)

(21) Appl. No.: 18/898,932

(22) Filed: Sep. 27, 2024

Related U.S. Application Data
(60) Provisional application No. 63/546,921, filed on Nov. 1, 2023.

(51) Int. Cl. B25J 9/16; B25J 13/08; B25J 15/04; B60D 1/62

(52) U.S. Cl. CPC B25J 9/1687; B25J 13/08; B25J 15/0491; B60D 1/62

(57) ABSTRACT

A gladhand coupling tool can be releasably connected to a robotic arm assembly and configured to connect to a gladhand receptacle of a trailer. The gladhand receptacle can be rotatable between a first position and a second position. In the first position, a pneumatic port of the gladhand receptacle can face a front surface of the trailer. In the second position, the pneumatic port can be exposed. One of the gladhand coupling tool and the robotic arm assembly includes a rotation member, which can interface with a portion of the gladhand receptacle so as to rotate the gladhand receptacle from the first position to the second position in preparation for connecting the gladhand coupling tool to the gladhand receptacle.

### CROSS-REFERENCE TO RELATED APPLICATIONS

This application claims benefit of and priority under 35 U.S.C. § 119(e) to and is a non-provisional of U.S. Provisional Patent Application No. 63/546,921, filed Nov. 1, 2023, and entitled “Autonomous Gladhand Coupling Systems, Devices, and Methods,” which is hereby incorporated by reference herein in its entirety.

This application is also related to U.S. application Ser. No. 18/282,022, filed Sep. 14, 2023, and entitled “Autonomous Gladhands Coupling Systems Devices, and Methods,” now U.S. Pat. No. 11,999,206, which is hereby incorporated by reference herein its entirety.

### FIELD

The present disclosure relates generally to tractor-trailer systems, and more particularly, to autonomous coupling between a truck and a semi-trailer system, for example, gladhand couplers for trailer pneumatic brakes.

### BACKGROUND

An 18-wheeler or tractor-trailer truck includes a semi-trailer (also referred to herein as “trailer”) releasably coupled to a tractor (also referred to herein as “truck” or “vehicle”). At distribution centers, marine terminals, rail heads, etc., the trailer is often disconnected from the truck, for example, for cargo loading, cargo unloading, storage, or changing between trucks. In such locations, rather than the truck used for road hauling, the trailer can be moved about by a specialized local tractor (also referred to herein as “hostler,” “hostler truck,” “yard truck,” “yard dog,” “terminal tractor,” “shuttle truck,” or “shunt truck”). However, trailers have a pneumatic parking brake (also referred to “spring brake” or “emergency brake”) that mechanically engage when the tractor's pressurized pneumatic lines are disconnected (e.g., via gladhand couplers on the trailer). Thus, to allow movement of the trailer by the hostler, the trailer parking brake has to be disengaged by pressurizing the pneumatic lines. This requires manually connecting pneumatic lines between hostler and the trailer, as automatic connection tends to be difficult or subject to failure. Not only does manual connection of pneumatic lines require additional time and subject a user to potential risk, but it also limits the adoption of automation (e.g., automating operation of the hostler to move trailers) at such locations. Embodiments of the disclosed subject matter may address one or more of the above-noted problems and disadvantages, among other things.

### SUMMARY

Embodiments of the disclosed subject matter provide systems, methods, and devices for autonomous or automated (e.g., remote controlled but without human contact with the coupler) connection of pneumatic supply lines via gladhand couplers. In some embodiments, a positionable arm (e.g., robotic arm assembly) with a detachable coupling tool can be used to couple and/or decouple a pneumatic line (e.g., from a tractor or from a trailer) to a conventional gladhand receptacle (e.g., on a trailer, on a tractor, or on another trailer). In some embodiments, the detachable coupling tool can be removably or releasably mounted on the positionable arm (e.g., via magnetic attraction, vacuum force, or actuatable mechanical coupling), for example, to allow the tool to be retained with the gladhand receptacle after the positionable arm is retracted and/or stowed.

In one or more embodiments, a system can comprise a vehicle, a robotic arm assembly, a gladhand coupling tool, and an air supply line. The vehicle can comprise a pneumatic source of pressurized air. The robotic arm assembly can be supported on or coupled to the vehicle. The gladhand coupling tool can be releasably connected to the robotic arm assembly. The gladhand coupling tool can be configured to connect to a gladhand receptacle of a trailer. The air supply line can be coupled to the gladhand coupling tool. The air supply line can be configured to deliver pressurized air from the pneumatic source to a braking system of the trailer when the gladhand coupling tool is connected to the gladhand receptacle of the trailer. The gladhand receptacle can be rotatable between a first position and a second position. In the first position, the gladhand receptacle can have an orientation with respect to a front surface of the trailer, such that a pneumatic port of the gladhand receptacle faces the front surface. In the second position, the gladhand receptacle can have a different orientation with respect to the front surface, such that the pneumatic port is exposed. One of the gladhand coupling tool and the robotic arm assembly can include a rotation member constructed to interface with a portion of the gladhand receptacle so as to rotate the gladhand receptacle from the first position to the second position in preparation for connecting the gladhand coupling tool to the gladhand receptacle.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Where applicable, some elements may be simplified or otherwise not illustrated in order to assist in the illustration and description of underlying features. Throughout the figures, like reference numerals denote like elements. An understanding of embodiments described herein and many of the attendant advantages thereof may be readily obtained by reference to the following detailed description when considered with the accompanying drawings, wherein:

FIGS. 1A-1C shows a truck coupled to a semi-trailer, a trailer supply connector station, and a rotatable gladhand receptacle, respectively, in a conventional tractor-trailer system;

FIGS. 2A-2D shows various stages for coupling a vehicle to a semi-trailer, including gladhand coupling via a robotic arm assembly, according to one or more embodiments of the disclosed subject matter;

FIG. 3A is a side view of a gladhand coupling tool, according to one or more embodiments of the disclosed subject matter;

FIGS. 3B-3C are cross-sectional views of the gladhand coupling tool of FIG. 3A;

FIGS. 4A-4G show various stages in connecting the gladhand coupling tool of FIGS. 3A-3C to a rotatable gladhand receptacle, according to one or more embodiments of the disclosed subject matter;

FIGS. 5A-5F show different rotation member configurations for a gladhand coupling tool, according to one or more embodiments of the disclosed subject matter;

FIGS. 6A-6B show side and cross-sectional views, respectively, of a configuration for a gladhand coupling tool releasably attached to a robotic arm assembly, according to one or more embodiments of the disclosed subject matter;

FIGS. 6C-6E show different configurations for a gladhand coupling tool releasably attached to a robotic arm assembly, according to one or more embodiments of the disclosed subject matter;

FIG. 6F show a configuration for a gladhand coupling tool releasably attached to a robotic arm assembly via a compliant interface, according to one or more embodiments of the disclosed subject matter;

FIG. 7 shows another configuration of a gladhand coupling tool and a robotic arm assembly having a rotation member, according to one or more embodiments of the disclosed subject matter;

FIG. 8 is a simplified diagram illustrating aspects of a gladhand coupling tool holder and robotic arm assembly, according to one or more embodiments of the disclosed subject matter;

FIG. 9 is a simplified schematic diagram of a vehicle system with autonomous gladhand coupling, according to one or more embodiments of the disclosed subject matter; and

FIG. 10 depicts a generalized example of a computing environment in which the disclosed technologies may be implemented.

### DETAILED DESCRIPTION

### I. Introduction

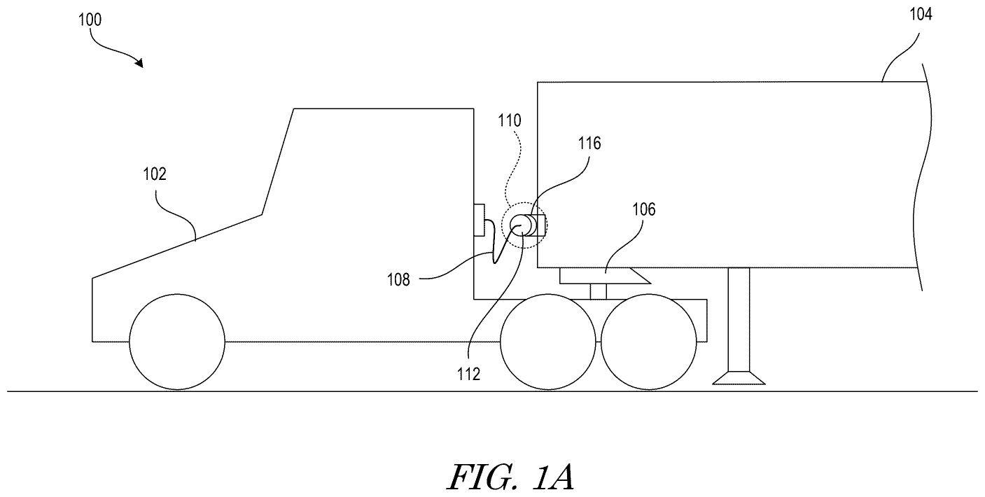

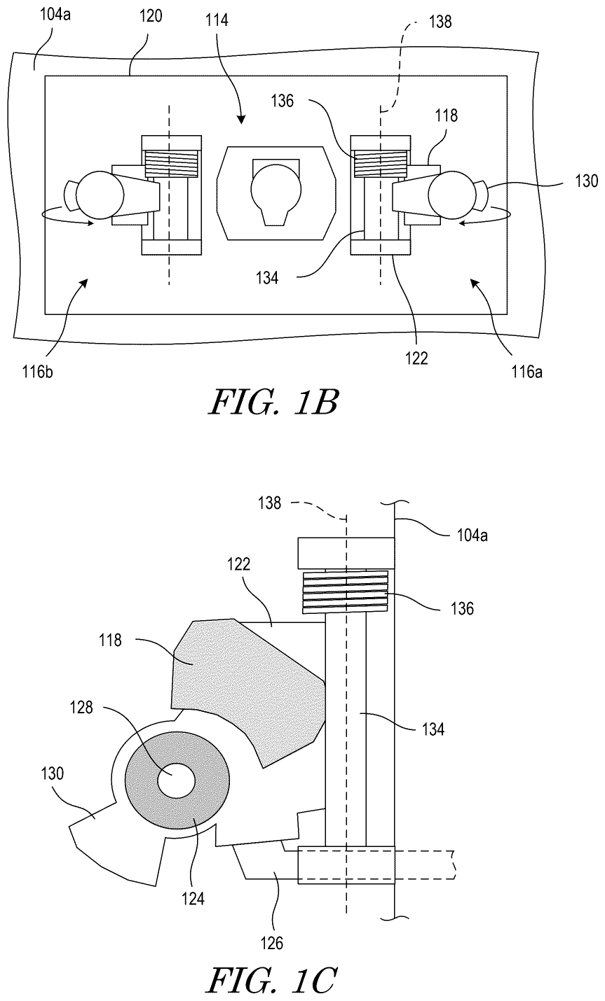

In a tractor-trailer system 100 (e.g., an 18-wheeler or tractor-trailer truck), a trailer 104 (also referred to herein as “semi-trailer”) is releasably coupled to a tractor 102 (also referred to herein as “truck” or simply “vehicle”) via a fifth-wheel connector 106, as shown in FIG. 1A. A supply coupling 110 between the tractor 102 and the trailer 104 is used to provide the braking system of the trailer 104 with pressurized air (e.g., via pneumatic supply line 108) from the tractor 102 and/or the electrical system of the trailer 104 with power from the tractor 102. In North America, there are usually two gladhand receptacles 116 corresponding to separate pneumatic lines of the trailer 104. One gladhand receptacle 116a (and corresponding pneumatic line) is pressurized to release the brake drums of the trailer 104 that otherwise provides a fail-safe state (e.g., with the brakes applied to the trailer). The other gladhand receptacle 116b (and corresponding pneumatic line) is used as the service brakes to assist the braking provided by wheels of the tractor 102. The application of pressure to the pneumatic lines is typically controlled by the tractor driver, e.g., either a human driver or an autonomous control unit (e.g., via a drive-by-wire system).

As shown in FIG. 1B, a connector station 120 (also referred to as a nose box) can be mounted on or part of a front-facing surface 104a of the trailer 104. The connector station 120 can have separate gladhand receptacles 116a, 116b flanking opposite lateral sides of an electrical receptacle 114, via which power can be applied to the electrical system of the trailer 104. Gladhands are designed to comply with one or more industry standards, such as Society of Automotive Engineers (SAE) J318_202106, “Automotive Air Brake Line Couplers (Gladhands),” J318_202106, published Jun. 10, 2021, and/or International Organization for Standardization (ISO) 1728:2006, “Road vehicles-Pneumatic braking connections between motor vehicles and towed vehicles-Interchangeability,” published September 2005, both of which are incorporated herein by reference. Different colors may be used to indicate gladhands and/or pneumatic lines corresponding to the service and emergency brakes (e.g., blue and red, respectively). In general, the same connector configuration may be used for the gladhand for each pneumatic line. Although particular connection station and receptacle configurations are shown, other configurations are also possible, such as but not limited to left offset (e.g., displaced from center of the trailer toward the driver side), centered (e.g., on a front side of the trailer), recessed (e.g., with respect to a front face of the trailer), provided on a chassis (e.g., instead of a portion of the trailer wall), and/or protected (e.g., with one or more horizontally or vertically extending members along or adjacent to a perimeter of the connector station).

In some embodiments, the gladhand receptacle 116 can extend longitudinally (e.g., straight (e.g., 90°) or at an angle (e.g., 45°)) from the front face of the trailer (e.g., toward the truck). Alternatively, in some cases, the gladhand receptacle may initially extend laterally, for example, with its pneumatic port facing toward the front face of the trailer, for example, as shown in FIG. 1B. In the illustrated example, each gladhand receptacle 116a, 116b extends initially along a lateral direction of the trailer 104 and is supported on mounting member 122 via a rotatable shaft 134, which can allow the receptacle to be rotated about vertical rotation axis 138. In some embodiments, the gladhand receptacle can be rotated about its respective rotation axis 138 such that it extends substantially longitudinally, for example, as shown in FIG. 1C. In some embodiments, the gladhand receptacle 116 can be biased by spring 136 toward the lateral-extension (e.g., stowed or retracted) orientation.

As shown in FIG. 1C, each gladhand receptacle 116 can have an alignment member 118 (also referred to as a connector plate), a mounting member 122 (also referred to as a bracket), a sealing member 124 (also referred to as a gasket or grommet), a lug 130 (with or without a separate detent plate attached), and a body extending between the lug 130 and the alignment member 118 and comprising and/or defining a pneumatic port 128. The gladhand receptacle 116 can be coupled to the trailer 104 (directly to the front surface 104a or indirectly via one or more intervening members) via mounting member 122 and/or rotatable shaft 134. The alignment member 118 can be designed to interface with a cam flange (e.g., lug and/or detent plate) of the standard gladhand coupler 112 to help position and retain the gladhand coupler thereto. A pneumatic line 126 can be in fluid communication with the trailer braking system and the pneumatic port 128. When connected to the gladhand coupler 112, the sealing member 124 of the receptacle 116 can interface with a corresponding member or surface of the gladhand coupler 112 to seal the area surrounding pneumatic port 128, such that pressurized air from the gladhand coupler 112 can be provided to the trailer braking system via the pneumatic port 128 and pneumatic line 126. Although a particular hinged gladhand receptacle configuration is shown in FIG. 1C, other configurations (with or without accompanying shutoff valve) are also possible, such as but not limited to fixed straight (e.g., 90°, or extending substantially horizontal), fixed angled (e.g., 45°, or extending at angle downward with respect to a horizontal plane), hinged straight, and/or hinged angled. Moreover, in some embodiments, the gladhand receptacle can deviate from a standard or normal configuration or state, such as but not limited to having a damaged or missing seal (e.g., grommet), misaligned from a straight or angled configuration, and/or having a lock connected thereto.

Coupling a gladhand coupler 112 to a gladhand receptacle 116 in conventional systems requires a human to manually rotate, connect, and disconnect the pneumatic lines; however, such configurations may not be conducive to partially or fully autonomous operation. Although trailers may be designed with newer versions of gladhand receptacles that are easier to autonomously connect, a large number of trailers in operation have been built and will continue to be built with conventional gladhand configurations. Disclosed herein are tractor-trailer systems, configurations, and methods that facilitate autonomous (semi-autonomous or automated) operation, for example, transport via an autonomous vehicle (e.g., truck or hostler). In some embodiments, the vehicle coupled to the trailer is an autonomous truck or vehicle, for example, a yard hostler. In some embodiments, the features of the tractor and/or the system can reduce the amount of manual intervention and/or human oversight required for transport of the trailer.

In some embodiments, the existing gladhand receptacle on the trailer (or on the truck or another trailer) can be retained, while the gladhand coupler that connects thereto can be modified to allow for robotic or automated positioning and coupling. In some embodiments, an autonomous gladhand coupling system can employ a robotic arm assembly (e.g., having one or more telescoping arm segments, one or more linear actuators, and/or one or more support cables) and a gladhand coupling tool (e.g., end effector) releasably supported by the robotic arm assembly. The gladhand coupling tool can be configured to mate with the existing gladhand receptacle. For example, the robotic arm can be extendable from a rear of a tractor toward the gladhand receptacle on the trailer (or on the front of a trailer extendable toward a gladhand receptacle on a truck, or on the rear of a first trailer extendable toward a gladhand receptacle on a second trailer). In some embodiments, the autonomous gladhand coupling system can be integrated with the vehicle (e.g., where the truck is manufactured with the robotic arm assembly and/or coupling tool library built in), or it can be an aftermarket add-on to the vehicle (e.g., as one or more modular units coupled to a rear of the truck). Similarly, when the autonomous gladhand coupling system is on the trailer, it can be integrated with the trailer (e.g., where the trailer is manufactured with the robotic arm assembly and/or coupling tool library built in), or it can be an aftermarket add-on to the trailer (e.g., as one or more modular units coupled to a front or rear sidewall of the trailer).

### II. Autonomous Gladhand Coupling via Robotic Arm Assembly

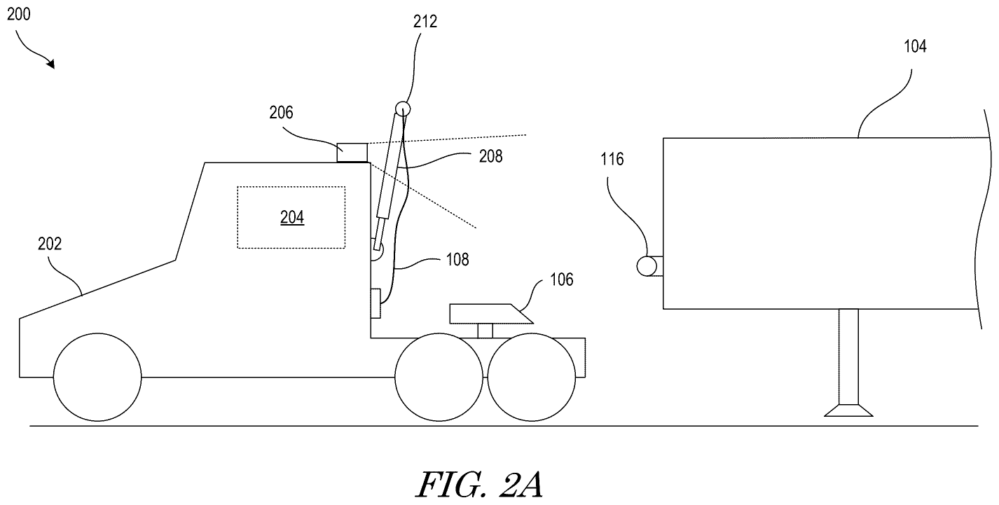

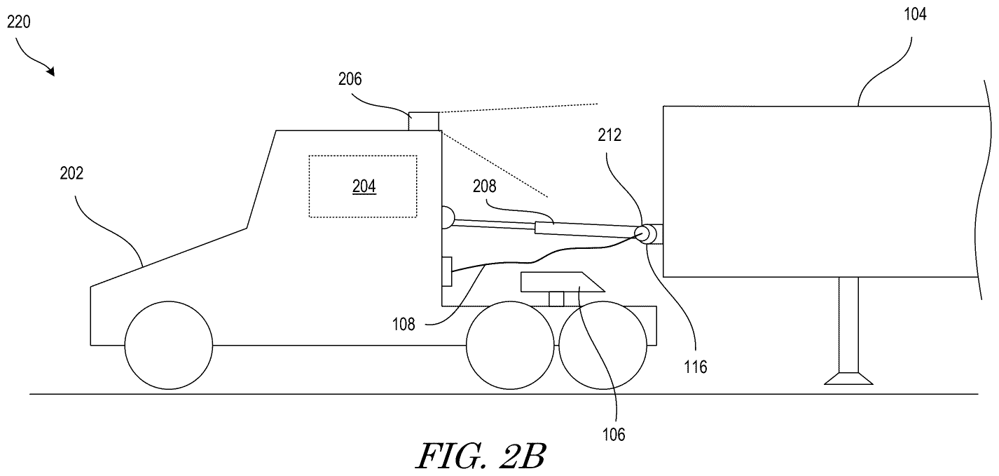

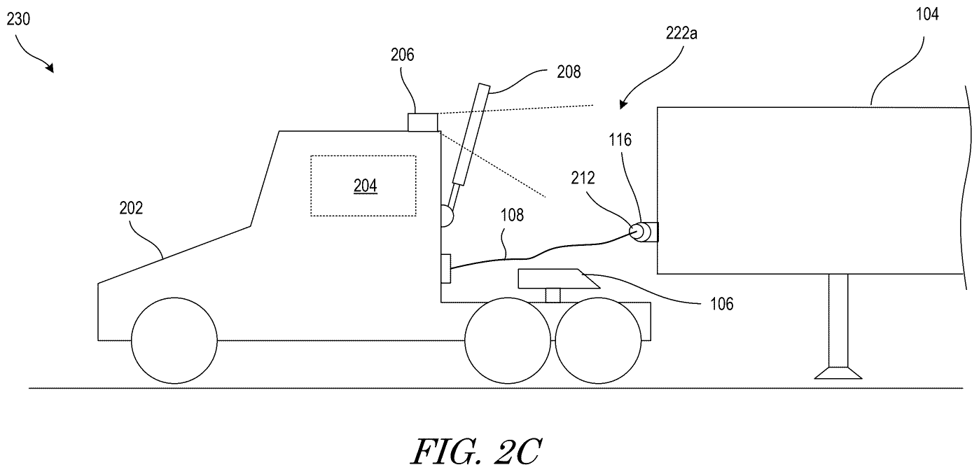

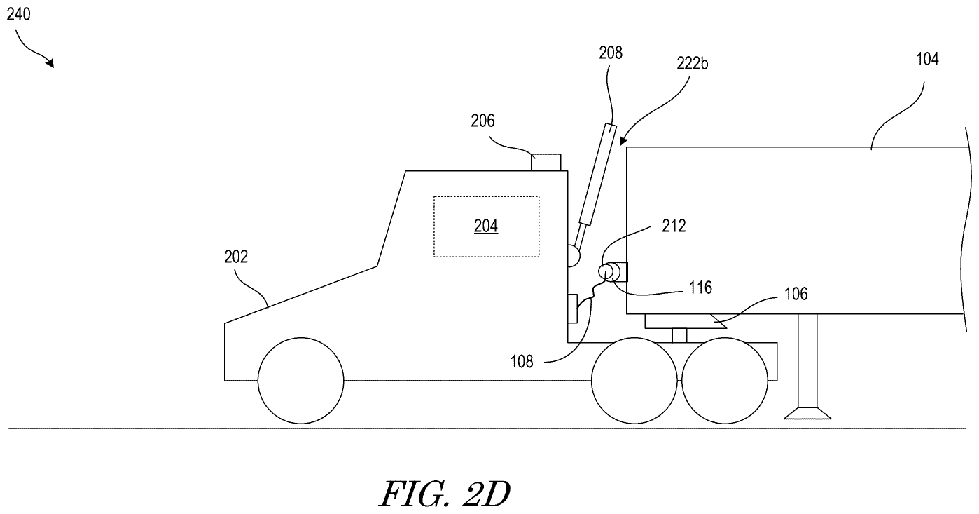

In some embodiments, a robotic arm assembly 208 (e.g., telescoping arm) can be used to autonomously couple a pneumatic line 108 from a vehicle 202 to a gladhand receptacle 116 of a trailer 104, for example, as shown in FIGS. 2A-2D. In some embodiments, the vehicle 202 is an autonomous vehicle, for example, with a control system 204 for controlling operation of the vehicle 202. In some embodiments, control system 204 may also control operation of the gladhand coupling system, for example, to control movement of the robotic arm assembly for positioning gladhand coupling tool 212 with respect to the receptacle 116, to control actuation of the coupling tool 212 to engage the receptacle 116, and/or to control movement of the robotic arm assembly without coupling tool 212 to a stowed position. Alternatively, in some embodiments, a control system for controlling operation of the robotic arm assembly can be separate from and/or communicate with control system 204. Alternatively or additionally, in some embodiments, operation of the robotic arm assembly 208 can be remotely controlled, for example, by a human operator at a remote station (e.g., teleoperated) or by a remote autonomous control system.

In some embodiments, the vehicle 202 and/or gladhand coupling system can be provided with one or more sensors, for example, to detect a type, location, and/or orientation of the gladhand receptacle 116 and/or a location of the coupling tool 212 (e.g., during positioning and/or after positioning, for example, to retrieve the coupling tool 212 when the trailer 104 is being decoupled from the vehicle 202). For example, a sensor 206 can be provided on a cabin roof of the vehicle 202 and can have a rearward-facing field-of-view for detecting aspects of the gladhand receptacle 116. Other locations for sensor 206 are also possible, such as but not limited to a rear surface of the vehicle cabin, a side surface of the vehicle cabin, a portion of the vehicle body supporting the fifth-wheel connector 106, a portion of the robotic arm assembly 208, a portion of the coupling tool 212, and/or a surface of the trailer 104.

In the illustrated example of FIGS. 2A-2D, the coupling tool 212 can be releasably mounted to an end of the robotic arm assembly 208. During the approach stage 200 of FIG. 2A, a rear end of the vehicle 202 can approach a front end of the trailer 104, with the robotic arm assembly 208 oriented close to the vehicle 202 and with the coupling tool 212 retained at the end of the arm assembly 208. In some embodiments, the gladhand receptacle 116 can be rotated about its respective rotation axis (e.g., axis 138 in FIGS. 1B-1C) from the initial lateral-extension orientation prior to coupling the coupling tool 212 thereto via robotic arm assembly 208. In some embodiments, the vehicle 202 (e.g., via the control system 204 and/or sensor 206) can identify the gladhand receptacle 116 and/or features thereof, and the robotic arm assembly 208 can be used to autonomously rotate the receptacle 116 from its stowed orientation for subsequent coupling thereto. For example, during the approach stage 200 (or any other stage), the gladhand receptacle 116 can be imaged or otherwise detected by sensor 206, and the rotation axis 138 identified (e.g., based on an identified location of the shaft 134). Alternatively or additionally, one or more gripping features of the receptacle 116 can be identified, for example, the lug 130 (or detent plate). The towing system may automatically assess the distance between the rotation axis 138 and part of lug 130 or detent plate (e.g., a laterally outermost point) and can plan a path (e.g., arc) for an end of the robotic arm assembly 208 and/or coupling tool 212 to travel.

During the gladhand coupling stage 220 of FIG. 2B, the vehicle 202 can further approach the trailer 104, and/or the robotic arm assembly 208 can be moved into position with respect to the trailer gladhand receptacle 116. In some embodiments, the robotic arm assembly 208 and or the coupling tool 212 can have a means for grasping and/or actuating (e.g., a rotation member, such as but not limited to a hook, claw, grip, lasso, snare, or noose) the gladhand receptacle 116 from its stowed position. For example, the movement of the robotic arm assembly 208 can be such that the means for grasping and/or actuating remains engaged with the lug 130 (or any other part of the receptacle) while pulling the gladhand receptacle 116 out of its stowed position in preparation for the coupling stage 220. Alternatively, in some embodiments, the robotic arm assembly can be different than the assembly used to couple the coupling tool 212 to the gladhand receptacle 116. For example, a separate robotic arm can be used to hold the receptacle 116 in position (e.g., partially or fully rotated out away from the trailer front-facing surface) while the robotic arm assembly 208 connects the coupling tool 212 to the gladhand receptacle 116.

Alternatively or additionally, in some embodiments, a specialized tool for positioning the gladhand receptacle for coupling can be mounted or otherwise integrated with the robotic arm assembly and/or the coupling tool itself. For example, the specialized tool can utilize an engagement member, and one or more actuators can be coupled to the engagement member. In some embodiments, the one or more actuators can be configured to move the engagement member relative to the robotic arm assembly. For example, the one or more actuators can include, but is not limited to, a rotary actuator, a linear actuator, a cable actuator, or any combination of the foregoing. In some embodiments, the engagement member can be positioned behind a distal portion of the gladhand receptacle, for example, proximal to the lug 130 or detent plate (e.g., between the trailer front surface and the lug or detent plate). The one or more actuators can then move the engagement member (either alone while the robotic arm remains stationary or in combination with movement of the robotic arm) to contact the distal portion of the gladhand receptacle and to rotate about its rotation axis out of its stowed position.

Once the gladhand receptacle 116 has been partially or fully rotated from its stowed position in the coupling stage 220, the robotic arm assembly 208 can then be moved such that an air supply outlet of the coupling tool 212 is aligned with the pneumatic port of the receptacle 116, after which the supply outlet can be mated with the pneumatic port, for example, by clamping the coupling tool 212 to the receptacle 116. Once effectively coupled to the receptacle 116, the coupling tool 212 can then be de-coupled from the robotic arm assembly 208, and the robotic arm assembly 208 can be retracted and/or returned to a stowed position, for example, as shown in stage 230 of FIG. 2C. Finally, the vehicle 102 can further approach the trailer 104 to connect and lock the fifth-wheel connector 106 to the trailer 104, as shown in the trailer attachment stage 240 of FIG. 2D. Air can be supplied to lines 108, such that the emergency brakes on the trailer are released and/or the service brakes are functional. In some embodiments, the reverse steps can be followed when the trailer is decoupled from the vehicle.

In some embodiments, the retraction of the arm assembly 208 in stage 230 can allow for free movement between the vehicle 202 and the trailer 104, which may aid in performing standard maneuvers). Alternatively or additionally, the clearance 222a between the rear of the vehicle cabin and the front of the trailer prior to connecting the fifth-wheel connector 106 may allow for greater freedom of movement for the arm assembly 208, while connecting the fifth-wheel connector 106 to the trailer 104 may reduce clearance 222b to a narrower region (e.g., along the longitudinal direction, which may be further reduced during turning maneuvers) that could otherwise inhibit free movement of the arm assembly 208. Alternatively, in some embodiments, the connection of the coupling tool 212 to the gladhand receptacle 116 may occur only after the fifth-wheel connector 106 is attached to the trailer 104.

### III. Gladhand Coupling Tool Examples

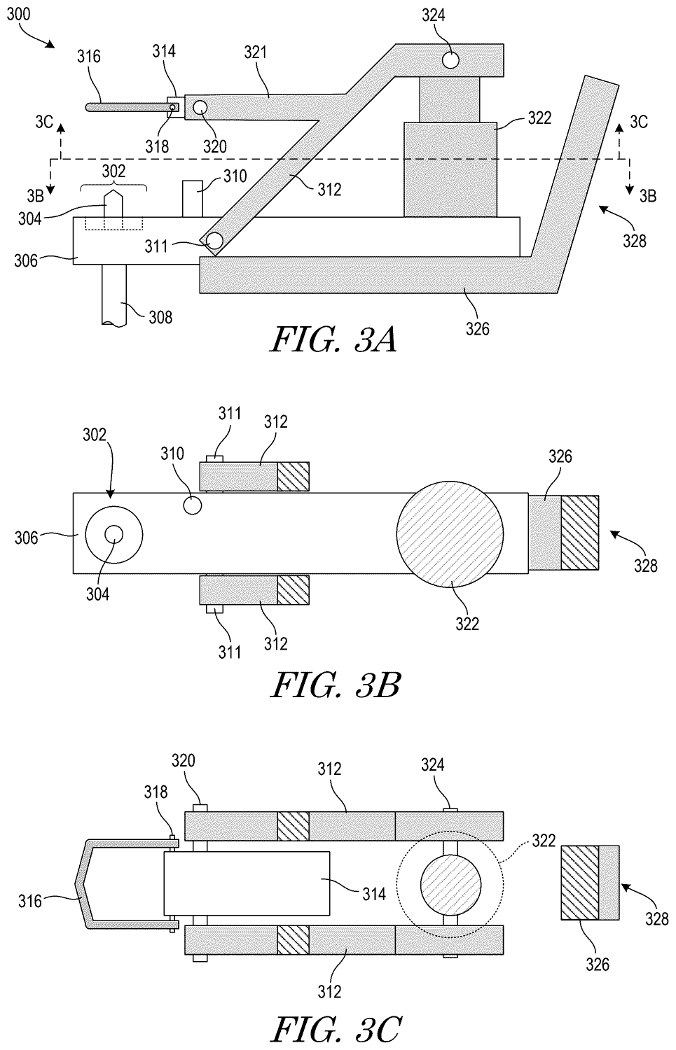

In some embodiments, a gladhand coupling tool can be releasably mounted to an end of a robotic arm assembly and can include one or more members or components (e.g., rotation tool) for displacing a gladhand receptacle from a stowed position (e.g., facing a front surface of a trailer) for connecting the gladhand coupling tool to the gladhand receptacle. For example, as shown in FIGS. 3A-3C, a gladhand coupling tool 300 can have a first frame member 306 comprising and/or defining a connection interface 302, a second frame member 312 comprising and/or defining a back-side clamping portion 321, and an arm support member 326 comprising and/or defining an arm coupling face 328. The connection interface 302 can include an internal alignment member 304, for example, designed to fit within a pneumatic port 128 of the gladhand receptacle 116. A pneumatic supply line 308 can be fluidically connected to the connection interface 302, for example, to provide pressurized air to the pneumatic port 128 when connected and sealed to the gladhand receptacle 116.

The second frame member 312 can be movably connected to the first frame member 306, for example, via rotatable coupling or pivot 311. In the illustrated example, an actuator 322 can be coupled between the first frame member 306 and the second frame member 312, for example, via one or more rotatable couplings or pivots 324. In some embodiments, the actuator 322 can move the back-side clamping portion 321 with respect to the connection interface 302. In the illustrated example, the actuator 322 can linearly expand to rotate the second frame member 312 about pivot 311 so as to move the back-side clamping portion 321 toward the connection interface 302 (e.g., to seal the gladhand coupling tool 300 to the gladhand receptacle 116), and the actuator 322 can linearly contract to rotate the second frame member 312 above pivot 311 so as to move the back-side clamping portion 321 away from the connection interface 302 (e.g., to release the gladhand coupling tool 300 from the gladhand receptacle 116).

In some embodiments, the second frame member 312 can include a rotation tool 316, for example, mounted at an end of the back-side clamping portion 321. In the illustrated example, the rotation tool 316 is mounted to a rotation tool support member 314 (e.g., via a rotatable coupling or pivot 318), and the rotation tool support member 314 is mounted to the back-side clamping portion 321 (e.g., via rotatable coupling or pivot 320). In some embodiments, the rotation tool 316 is sized and/or shaped to allow a portion of the gladhand receptacle 116 to be grasped, snagged, or otherwise retained by the gladhand coupling tool 300 so as to allow rotation of the gladhand receptacle 116 from its stowed position. In some embodiments, the gladhand coupling tool 300 can include an external alignment member that interfaces with the gladhand receptacle 116 during connection and/or while connected. For example, the first frame member 306 can comprise and/or define an external alignment member 310 that abuts a portion of the gladhand receptacle 116 (e.g., an edge of lug 130 or detent plate) to assist in aligning the gladhand coupling tool 300 to the gladhand receptacle 116. Alternatively or additionally, the external alignment member 310 can abut the portion of the gladhand receptacle 116, for example, to resist and/or limit vertical movement (e.g., rotation) of the gladhand coupling tool 300 due to gravity when the coupling tool 300 is connected to the gladhand receptacle 116.

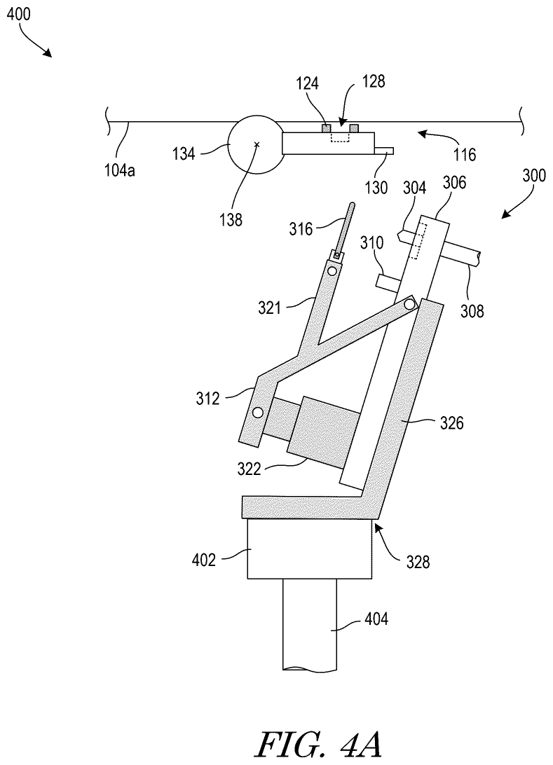

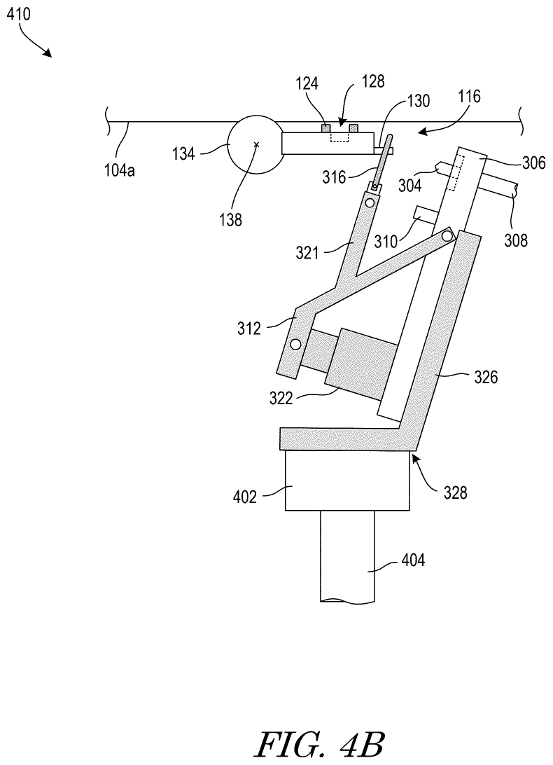

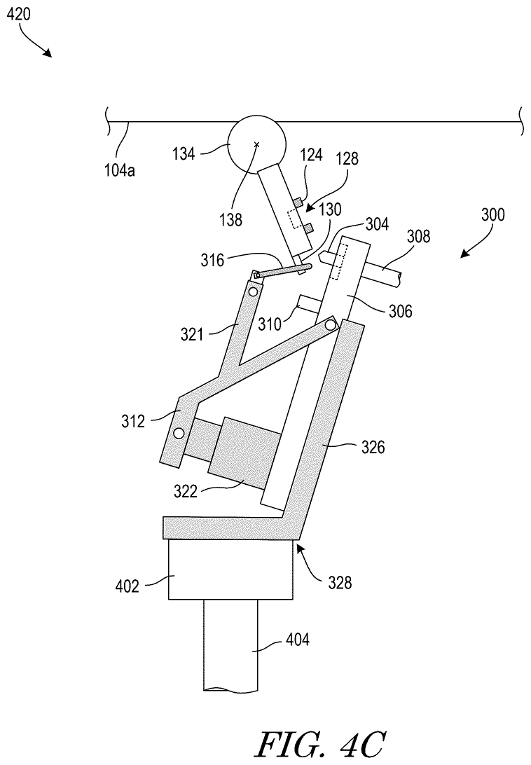

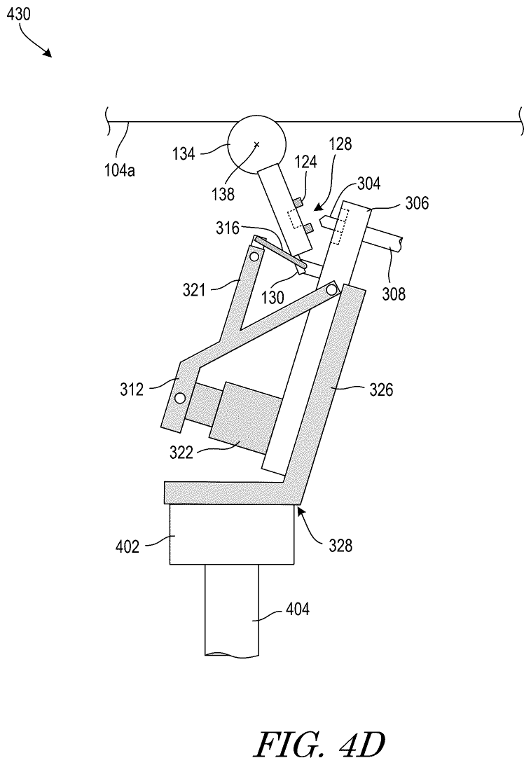

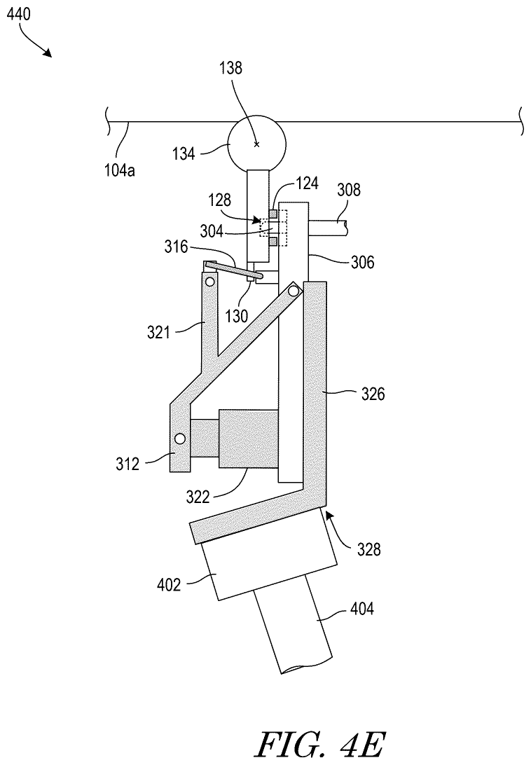

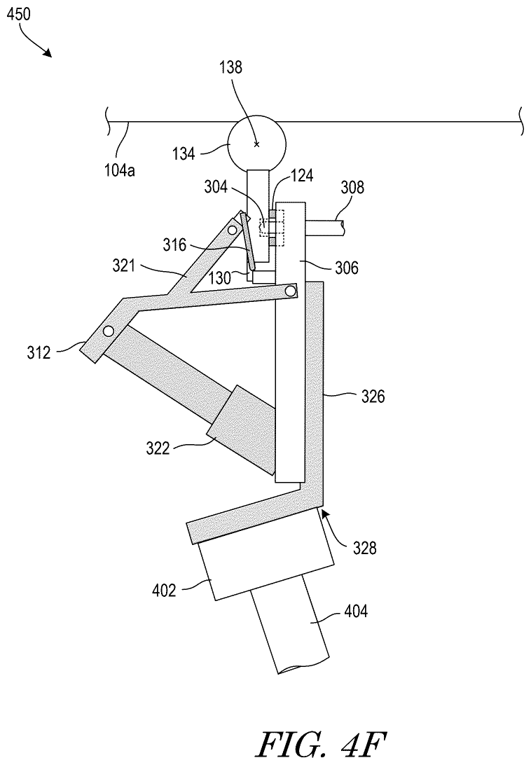

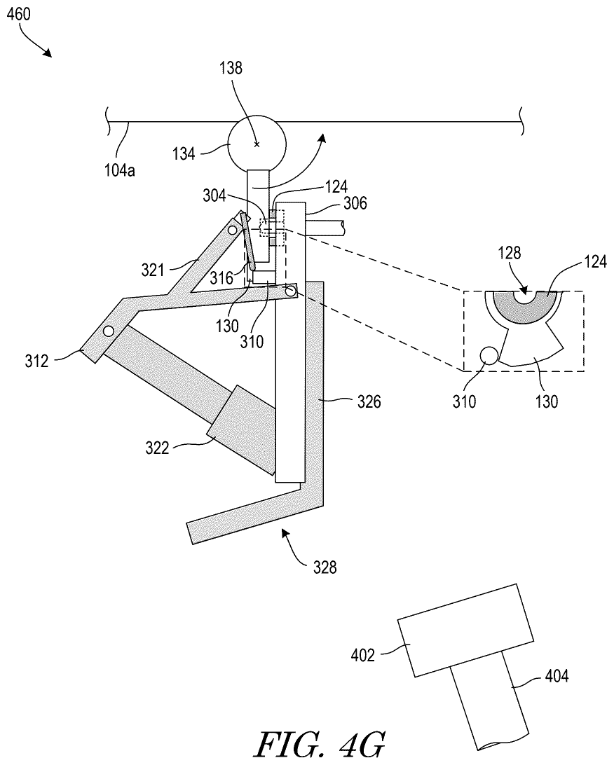

In some embodiments, the rotation tool 316 of the gladhand coupling tool 300 can be used to rotate the gladhand receptacle 116 from its stowed position prior to and/or concurrent with connecting the gladhand coupling tool 300 to the gladhand receptacle 116. For example, FIGS. 4A-4G illustrate an exemplary operation for connecting gladhand coupling tool 300 to gladhand receptacle 116. FIG. 4A illustrates an approach stage 400, where gladhand coupling tool 300 is positioned by a robotic arm 404 with respect to gladhand receptacle 116 in a stowed configuration, e.g., with pneumatic port 128 facing the front surface 104a of the trailer. The gladhand coupling tool 300 can be releasably mounted to the robotic arm 404 via a tool mating interface 402 in contact with arm coupling face 328. For example, the tool mating interface 402 can employ magnetic attraction force, vacuum force, mechanical retention force, or any other force to releasably retain the coupling tool 300 to the robotic arm 404.

FIG. 4B illustrates a grasping stage 410, where the robotic arm 404 moves the gladhand coupling tool 300 so that the rotation tool 316 is brought into contact with (e.g., looped around) the gladhand receptacle 116, for example, lug 130 (or detent plate). By moving the coupling tool 300, the robotic arm 404 can pull on lug 130 (or detent plate) via the rotation tool 316 to move (e.g., rotate) the gladhand receptacle 116 from its stowed position, thereby exposing the pneumatic port 128, as shown in rotation stage 420 of FIG. 4C. Without releasing the grip of the rotation tool 316 on the lug 130 (or detent plate), the robotic arm 404 can move the first frame member 306 of the coupling tool 300 such that connection interface 302 is proximal to the exposed sealing member 124 of the gladhand receptacle 116 (e.g., with alignment member 304 approaching and/or aligned with pneumatic port 128), as shown in positioning stage 430 of FIG. 4D. In alignment stage 440 of FIG. 4E, the robotic arm 404 can further move the first frame member 306 toward the gladhand receptacle 116, for example, such that the alignment member 304 is inserted into the pneumatic port 128 and/or the connection interface 302 is brought into contact with sealing member 124. In clamping stage 450 of FIG. 4F, the second frame member 312 can then be moved by the actuator 322 of the gladhand coupling tool 300 so as to bring the back-side clamping portion 321 into contact with a back-side of the gladhand receptacle 116, thereby sealing the connection interface 302 to the gladhand receptacle 116 and forming a sealed fluidic connection between the pneumatic supply line 308 (e.g., providing pressurized air from the vehicle 202) and the pneumatic brake line of the trailer.

Once clamped to the gladhand receptacle 116, the robotic arm 404 can be disconnected from the gladhand coupling tool 300, as shown in arm disconnect stage 460 of FIG. 4G. In some embodiments, the robotic arm 404 can return to a stowed position on the vehicle 202 after disconnection. Alternatively or additionally, the robotic arm 404 can be used to connect another coupling tool (e.g., for pressurized air or electricity from the vehicle) to another receptacle on the trailer. In the illustrated example of FIG. 4G, the external alignment member 310 of the coupling tool 300 abuts a portion of the gladhand receptacle 116 (e.g., lug 130 or detent plate) to prevent, or at least resist, rotation of the coupling tool 300 due to gravity. In some embodiments, once the robotic arm 404 is disengaged from the coupling tool 300, the gladhand receptacle 116 can rotate back toward its stowed position, for example, due to a spring force. In some embodiments, gladhand coupling tool 300 can be disconnected and/or retrieved from the gladhand receptacle 116 by the robotic arm 404 by reconnecting mating interface 402 to arm coupling face 328 and repeating the stages of FIGS. 4A-4G in reverse order.

### IV. Rotation Tool Examples

In some embodiments, the rotation tool can be movably coupled to the gladhand coupling tool (e.g., the second frame member 312 and/or the rotation tool support member 314), for example, to allow freedom of movement in rotation (e.g., about an axis extending substantially parallel to the rotation axis 138 of the gladhand receptacle 116 and/or a direction of gravity), as shown in FIGS. 3A-4G. Alternatively or additionally, in some embodiments, the rotation tool can be rigidly attached to the gladhand coupling tool (e.g., the second frame member 312 and/or the rotation tool support member 314). Alternatively or additionally, the movement (e.g., rotation) of the rotation tool relative to the rest of the gladhand coupling tool can be actively and/or passively controlled.

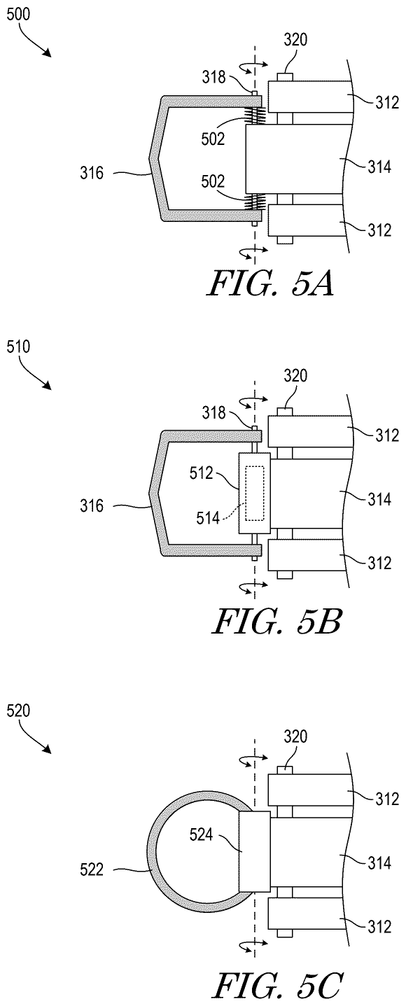

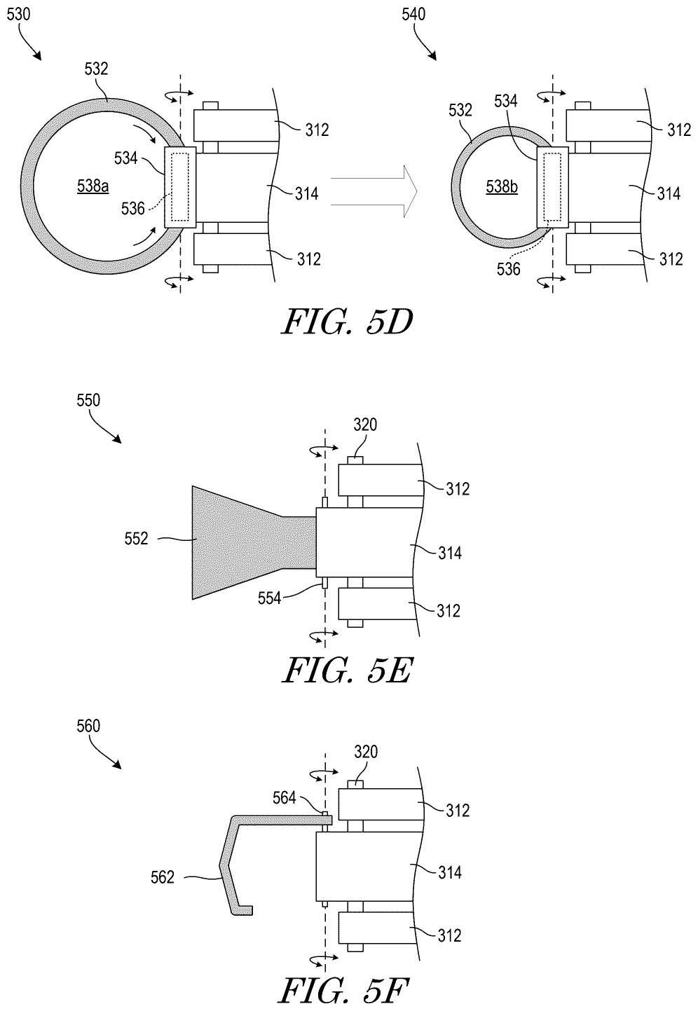

In some embodiments, the rotation tool can be configured as a hinged bail that can be sprung to a resting position and/or may be deflected to other positions. For example, FIG. 5A shows a rotation tool configuration 500 where the rotation tool 316 is coupled to a rotation tool support member 314 via a spring 502 and rotatable coupling 318. The spring 502 can bias the rotation tool 316 to return to a predetermined position at rest (e.g., before the rotation tool 316 is contacted with the gladhand receptacle 116). In the illustrated example of FIG. 5A, the rotation tool support member 314 is further rotatably coupled to the second frame member 312 by rotatable coupling 320; however, embodiments of the disclosed subject matter are not limited thereto. Rather, in some embodiments, the rotation tool support member 314 can be rigidly coupled to the second frame member 312, or the rotation tool 316 can be rotatably coupled directly to the second frame member 312 (e.g., without provision of a separate rotation tool support member 314).

FIG. 5B illustrates another rotation tool configuration 510 employing an active actuation system 512 that can control movement (e.g., rotation) of the rotation tool 316 with respect to the rest of the gladhand coupling tool. In some embodiments, the actuation system can articulate the rotation tool 316, with or without compliance, via one or more motors, pneumatic drives, hydraulic drives, magnets, springs, and/or other actuation modalities. In some embodiments, the active actuation system 512 can include its own controller 514 for controlling option thereof. Alternatively, in some embodiments, the active actuation system 512 can be controlled by vehicle control system 204 (or a control system of the robotic arm assembly 208, for example, if provided separate from the vehicle control system 204).

In some embodiments, the rotation tool can be shaped as a loop, for example, a metal wire (e.g., steel), a plastic wire, or a similarly-shaped elastic member (e.g., rubber). For example, the loop can be formed of a metallic or non-metallic twisted, braided, or mono-filament cord-like structure. In some embodiments, the wire forming the loop can be jacketed (e.g., with a protective sheath), layered (e.g., with an outer layer surrounding a core layer), or bare (e.g., having a single contiguous structure in cross-sectional view). In some embodiments, the loop can be flexible. For example, FIG. 5C shows a rotation tool configuration 520 where the rotation tool is formed as a wire loop 522 rotatably coupled to rotation tool support member 314 via hinge 524.

In the illustrated example of FIG. 5C, the wire loop 522 can be of fixed length. Alternatively, in some embodiments, the length of the wire loop may be adjustable, for example, to assist in grasping a portion of the gladhand receptacle for rotating from the stowed orientation. For example, FIG. 5D shows another configuration where a length of wire loop 532 can be changed via actuation system 534 that couples (e.g., rotatably) the wire loop 532 to rotation tool support member 314. The actuation system 534 (e.g., winch) can draw in the wire loop 532 to reduce an area 538a enclosed by the loop 532 in a deployed configuration 530 to the reduced area 538b in the tightened configuration 540. In some embodiments, actuation system 534 can include its own controller 536 for controlling option thereof. Alternatively, in some embodiments, the actuation system 534 can be controlled by vehicle control system 204 (or a control system of the robotic arm assembly 208, for example, if provided separate from the vehicle control system 204). Alternatively, in some embodiments, the length of the wire loop 532 can be changed via passive means, for example, using a retractable spring such as a coiled spring or clock spring.

Alternatively or additionally, in some embodiments, the rotation tool can have an active shape control mechanism. For example, the shape, size, and/or orientation (e.g., with respect to the rotation tool support member 314 and/or the second frame member 312) of the rotation tool can controlled via one or more internal actuation members, (e.g., tensile and/or compressive members), one or more shape memory materials (e.g., shape memory alloy such as nitinol), one or more pressure control devices (e.g., pneumatic or hydraulic), or any combination of the foregoing. Alternatively or additionally, the rotation tool can be capable of elongating, contracting, rotating, or otherwise actuating via thermal, electroactive, magnetic, ionic, or other actuation modalities.

In some embodiments, the rotation tool can be shaped as a simple loop (e.g., oval, polygonal, or any other regular or irregular shape (or portion thereof)). Alternatively or additionally, the rotation tool can include one or more additional shapes or features along the perimeter or circumference of the loop, for example, a pad. In some embodiments, at least part of the rotation tool can have one or more features designed, shaped, or otherwise constructed to increase or improve retention to a grasped portion of the receptacle, for example, a permanent magnet for attracting the metal material of the lug 130 (or detent plate).

Although FIGS. 3A-5D illustrate a loop shape for the rotation tool, embodiments of the disclosed subject matter are not limited thereto. Rather, other shapes and configurations are also possible according to one or more contemplated embodiments. For example, the rotation tool can comprise multiple pieces or segments that may or may not meet (e.g., a piecewise or discontinuous structure, such as a segmented or fragmented loop with an open portion). For example, FIG. 5F shows a rotation tool configuration 560 having a hook-shaped rotation tool 562 rotatably coupled to the rotation tool support member 314 via rotatable coupling or pivot 564. Other configurations without partially or fully enclosed areas are also possible. For example, FIG. 5E shows a rotation tool configuration 550 having a paddle or spatula-shaped rotation tool 552 rotatably coupled to the rotation tool support member 314 via rotatable coupling or pivot 554.

In some embodiments, the rotation tool can be rigidly or movably coupled to the rest of the gladhand coupling tool (e.g., rotation tool support member 314 and/or second frame member 312) via at least one point of attachment. In the examples of FIGS. 5A-5E, two points of attachments (e.g., at opposite ends of the rotatable coupling) are provided, while a single point of attachment is provided in the example of FIG. 5G. In some embodiments, two points of attachment can be replaced with a single point of attachment, or more than two points of attachment can be used. Alternatively, in some embodiments employing multiple separate pieces or segments for the rotation tool, each piece or segment can have its own point of attachment (or multiple points of attachment).

### V. Robotic Arm and Gladhand Coupling Tool Assembly Examples

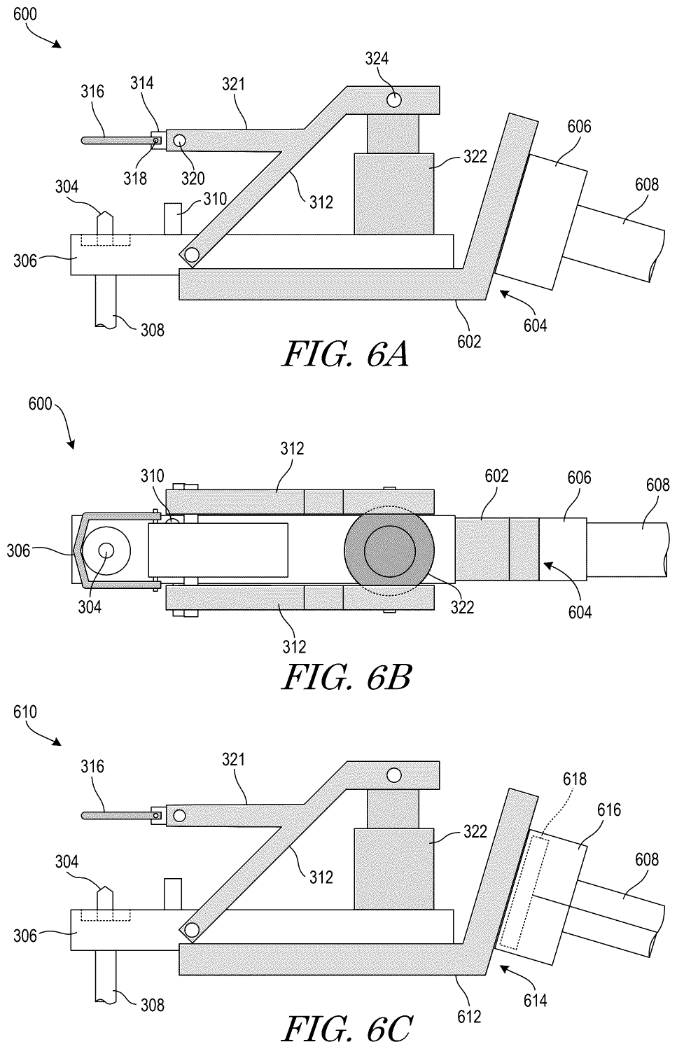

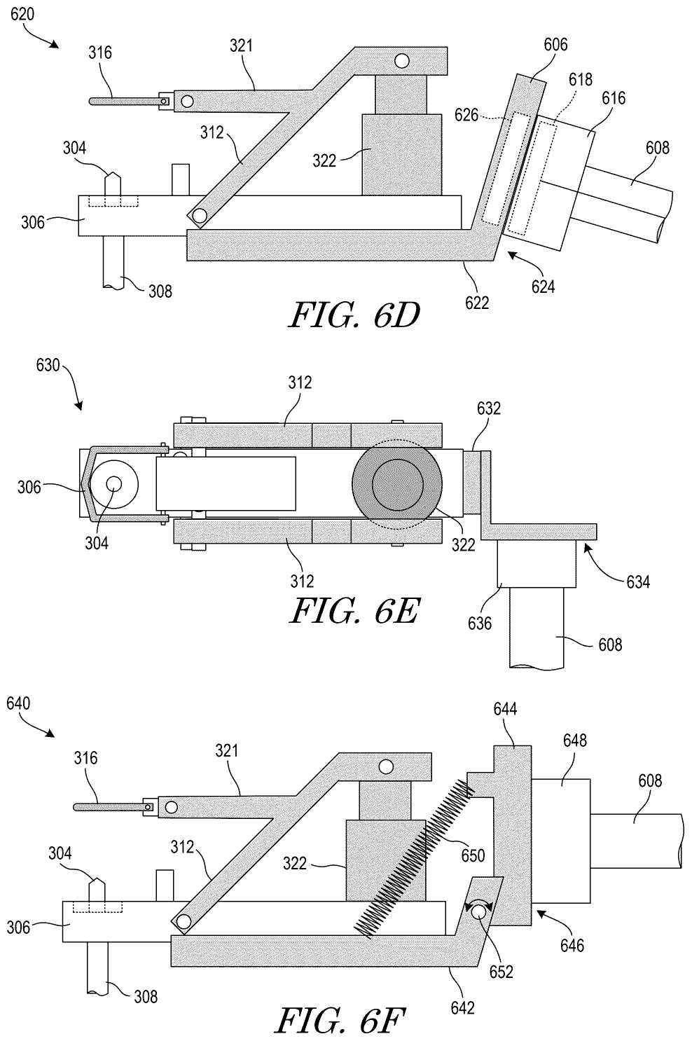

In some embodiments, the gladhand coupling tool can be releasably mounted at an end of a robotic arm assembly, for example, via magnetic, vacuum, and/or mechanical means. For example, FIGS. 6A-6B illustrate an exemplary tool-arm configuration 600 employing magnetic means. In the gladhand coupling tool, the first frame member 306 is attached to the arm support member 602, which has an angled arm coupling surface 604 that faces forward (e.g., toward the front of the vehicle) during the connecting to the gladhand receptacle. In some embodiments, the arm support member 602, or at least the arm coupling surface 604 thereof, can be formed of and/or comprise a magnetic material (e.g., steel), and the tool mating interface 606 can be formed of and/or comprise a permanent magnet. Magnetic attraction between the tool mating interface 606 and the arm coupling surface 604 can thus releasably retain the gladhand coupling tool at an end of the robotic arm 608.

FIG. 6C illustrates another exemplary tool-arm configuration 610 employing magnetic means. Similar to the example of FIGS. 6A-6B, the first frame member 306 is attached to arm support member 612, which has an angled arm coupling surface 614 that faces forward during the connecting to the gladhand receptacle. However, the arm support member 612, or at least the arm coupling surface 614 thereof, can be formed of and/or comprise a permanent magnet, and the tool mating interface 616 can comprise an electromagnet 618. When activated to have a polarity opposite to that of the permanent magnet of the arm coupling surface 614, magnetic attraction between the electromagnet 618 of the tool mating interface 616 and the permanent magnet of the arm coupling surface 614 can thus releasably retain the gladhand coupling tool at an end of the robotic arm 608. Alternatively or additionally, when release of the gladhand coupling tool from the robotic arm is desired, the polarity of the electromagnet 618 can be reversed, such that the like poles of the arm coupling surface permanent magnet and the tool mating interface electromagnet 618 repel.

FIG. 6D illustrates another exemplary tool-arm configuration 620 employing magnetic means. Similar to the example of FIG. 6C, the first frame member 306 is attached to arm support member 622, which has an angled coupling surface 624 that faces forward during the connecting to the gladhand receptacle. However, at least the arm coupling surface 624 can comprise an electromagnet 626, and the tool mating interface 616 can comprise an electromagnet 618. When activated to have opposite polarities, magnetic attraction between the electromagnets 618, 626 can thus releasably retain the gladhand coupling tool at an end of the robotic arm 608. Alternatively or additionally, when release of the gladhand coupling tool from the robotic arm is desired, the polarity of the electromagnet 618 or electromagnet 626 can be reversed, such that the like poles of the electromagnets 618, 626 repel.

In some embodiments, the orientation of the coupling surface and/or the tool mating interface can be different than the longitudinal orientation (e.g., front-to-back) shown in FIGS. 6A-6D, for example, having a lateral orientation (e.g., left-to-right). For example, FIG. 6E illustrates another exemplary tool-arm configuration 630 employing an arm support member 632 with laterally-oriented arm coupling surface 634 releasably coupled to tool mating interface 636. Unlike the configurations of FIGS. 6A-6D, the arm coupling surface 634 can face toward a side of the vehicle and/or trailer during the connecting to the gladhand receptacle. Such a configuration can improve control of the robotic arm and/or positioning of the gladhand coupling tool, for example, by simplifying the kinematics.

In some embodiments, the gladhand coupling tool can include one or more points of compliance between the frame members, the coupling surface, and/or the tool mating interface, for example, to avoid, or at least reduce, undesirable impact of forces at the end of the robotic arm (e.g., to avoid damaging the gladhand receptacle and/or the coupling tool due to movement of the robotic arm). For example, FIG. 6F illustrates another exemplary tool-arm configuration 640 where the first frame member 306 is attached to a base member 642 and an arm support member 644 is movably (e.g., rotatably) coupled to the base member via pivot or hinge 652. The gladhand coupling tool can be releasably coupled to the robotic arm 608 via a tool mating interface 648 in contact with the arm coupling surface 646 of the arm support member 644. A spring 650 or other flexible member can extend between an end of the arm support member 644 and the base member 642 (or first frame member 306), for example, to bias the arm support member 644 and the arm coupling surface 646 thereof in a predetermined orientation.

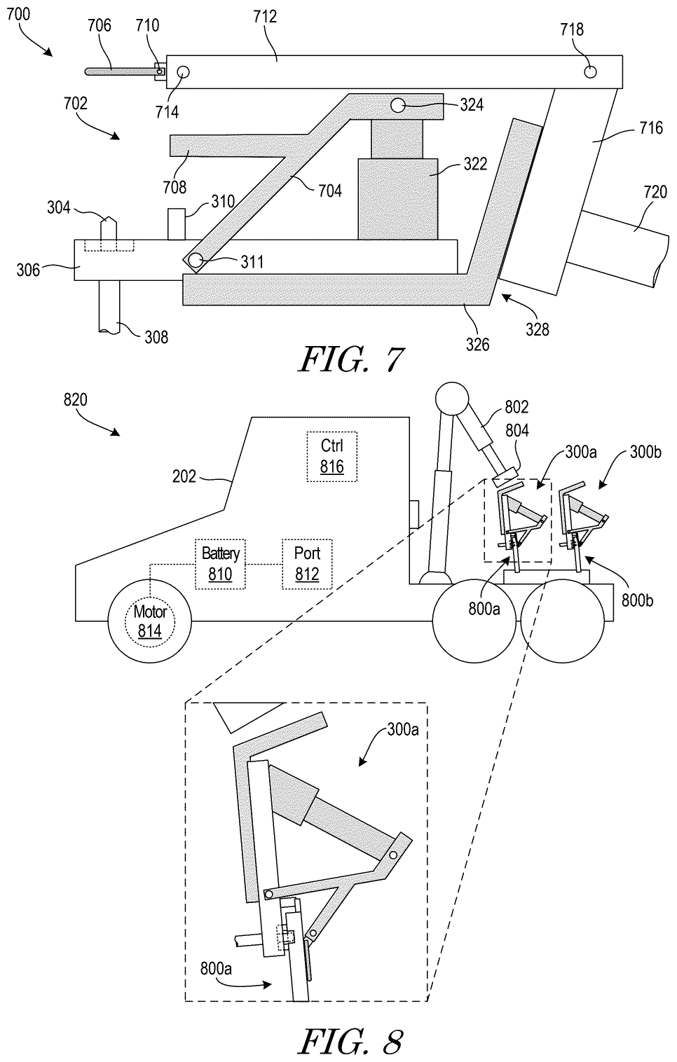

In the examples of FIGS. 2A-6F, the rotation tool is provided as part of the gladhand coupling tool (e.g., which separates from the robotic arm and stays with the trailer when the gladhand coupling tool is connected to the gladhand receptacle). However, embodiments of the disclosed subject matter are not limited thereto. Rather, in some embodiments, the rotation tool can be part of the robotic arm (e.g., the tool mating interface), a sub-arm of the robotic arm assembly, or a separate robotic arm. For example, FIG. 7 shows an exemplary arm-tool configuration 700 where the rotation tool 706 is on the robotic arm 720 instead of the gladhand coupling tool 702. Thus, the second frame member 704 of the gladhand coupling tool 702 can include a clamping portion 708 without a separate rotation tool, and the rotation tool 706 can be movably (e.g., rotatably) connected to a rotation tool support member via rotatable coupling or pivot 710. The rotation tool support member can also be movably (e.g., rotatably) connected to extension member 712 via rotatable coupling or pivot 714, and/or the extension member 712 can be movably (e.g., rotatably) connected to tool mating interface 716 (e.g., via rotatable coupling or pivot 718). Operation of configuration 700 may be similar to that illustrated in FIGS. 4A-4G, but with the rotation tool 706 being retained with the robotic arm 720 after the gladhand coupling tool 702 is deployed (e.g., disconnected from the arm 720) on the gladhand receptacle.

### VI. Coupling Tool Selection and Storage Examples

In some embodiments, a single robotic arm assembly can be used to sequentially or separately connect multiple coupling tools to respective receptacles on a trailer. For example, the robotic arm assembly can be used to connect one coupling tool to a service brake gladhand receptacle on the trailer, and to subsequently connect another coupling tool to an emergency brake gladhand receptacle on the trailer. Alternatively or additionally, the robotic arm assembly can connect other coupling tools to other pneumatic gladhand receptacles (e.g., for air-actuated machinery aboard the trailer) and/or to non-gladhand receptacles (e.g., connectors for electrical power). In some embodiments, the towing system (e.g., vehicle plus coupling system) can be provided with a library of multiple different coupling tools, from which the robotic arm assembly can select.

In some embodiments, the coupling tool library can be and/or comprise an active tool changer (e.g., that selects, dispenses, and/or positions one coupling tool from a plurality of coupling tools for mating with the robotic arm assembly). Alternatively or additionally, the coupling tool library can be and/or comprise a passive holder or magazine (e.g., where the robotic arm assembly can pick from a plurality of coupling tools in an array). For example, the vehicle can comprise a plate or cube to which each gladhand coupling tool can be clamped and/or retained via other means (e.g., magnetic attraction). Alternatively or additionally, in some embodiments, the vehicle can comprise one or more pseudo or faux gladhand receptacles to which one or more gladhand coupling tools can be connected (e.g., in a manner similar to actual connection to a trailer gladhand receptacle) while it awaits selection by the robotic arm for subsequent connection to the trailer. In some embodiments, the system can be configured to apply pressure to each gladhand coupling tool stored in the library (e.g., mounted on the respective faux receptacle), and the system can determine which gladhand coupling tool has been selected by the robotic arm based on the applied pressure and/or air flow (e.g., with air readily flowing from a coupling tool removed from the faux receptacle and prior to connecting with the actual receptacle on the trailer).

For example, FIG. 8 illustrates a configuration 820 for a vehicle 202 with a robotic arm assembly 802 and a pair of pseudo gladhand receptacles 800a, 800b having respective gladhand coupling tools 300a, 300b supported (e.g., clamped) thereon. A control system 816 can control operation of the robotic arm assembly 802, for example, to position a mating interface 804 with respect to the coupling surface of the desired gladhand coupling tool 300a, 300b. In some embodiments, the robotic arm assembly 802 (and/or control system 816) can be configured to connect an electrical cable to a charging port 812 of vehicle 202, for example, to recharge a battery pack 810 used to power an electrical motor 814 of the vehicle 202. Although only two coupling tools and pseudo receptacles are shown in FIG. 8, any number of coupling tools and pseudo receptacles can be provided. Moreover, although FIG. 8 illustrates the same type of coupling tools 300a, 300b, embodiments of the disclosed subject matter are not limited thereto. Rather, one or more different types of coupling tools can be provided, for example, to allow connection to different types of gladhand receptacles, different types of trailers, and/or different trailer components (e.g., electrical connections).

Alternatively or additionally, in some embodiments, the robotic arm assembly can be configured to connect appropriate coupling tools to the two gladhand receptacles (e.g., service line and parking or emergency brake line) of the trailer, an electrical connector to an electrical receptacle for the brake lights of the trailer (or an electrical connection to the trailer for any other purpose), and/or an electrical connector to the vehicle (e.g., for automated charging of the vehicle itself, for example, via power lines that charge the vehicle from an external source). In some embodiments, the robotic arm assembly can employ grippers that stay with the cables/pneumatic lines. For example, the robotic arm assembly can have a universal magnetic end (e.g., wrist), and different attachments (e.g., hands) can be used depending on the type of connection desired (e.g., service line gladhand, parking line gladhand, electrical trailer lighting, vehicle recharge, etc.). The different attachments can be held in a rack or other holding area (e.g., mounted on the vehicle or proximal to the vehicle) when not in use, and the robotic arm can pick one of the attachments from the rack when a particular connection is needed. In some embodiments, each attachment (e.g., coupling tool) can have different magnetic attachment points, for example, one for attaching to the robotic arm assembly and another for attaching to the rack for storage when not in use. In some embodiments, these different magnetic attachment points can be different in size, shape, orientation, or any other characteristic, for example, to improve localization and/or mechanical stability when in transport and/or in storage.

### VII. Vehicle Systems with Autonomous Gladhand Coupling

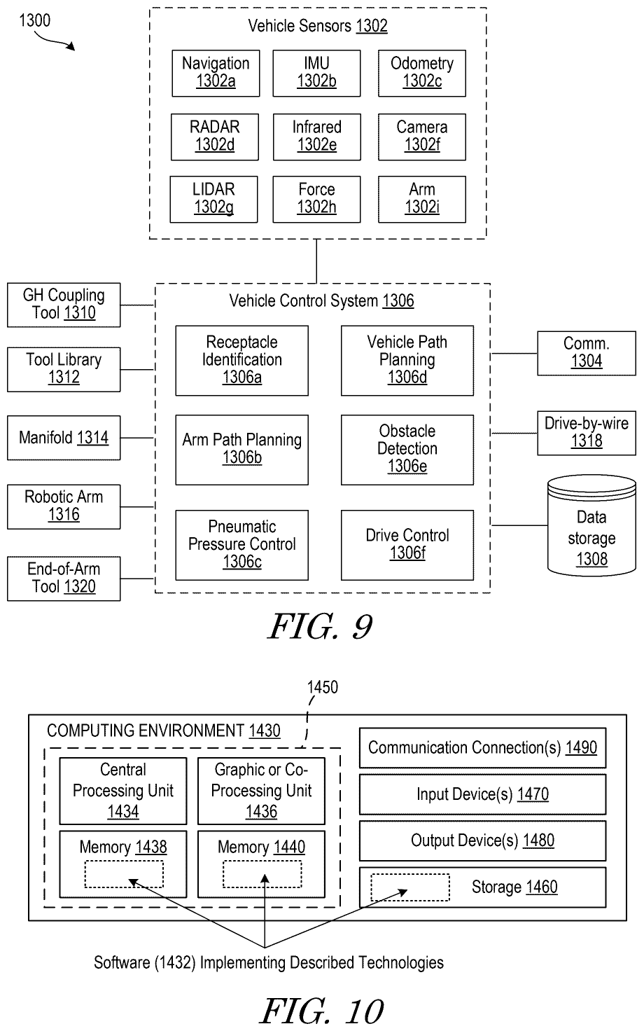

FIG. 9 illustrates an exemplary configuration of a vehicle system 1300 that can facilitate autonomous operation, for example, by using a robotic arm assembly to provide gladhand coupling between a towing vehicle and a towed trailer in an autonomous or automated manner. The system 1300 can include a vehicle control system 1306, one or more vehicle sensors 1302, a drive-by-wire system 1318, one or more gladhand coupling tools 1310, a tool library 1312, an air pressure manifold 1314, a robotic arm assembly 1316, an optional end-of-arm tool 1320, and a communication unit 1304. The drive-by-wire system 1318 can include, for example, electrical and/or electro-mechanical components for performing one or more vehicle functions traditionally provided by mechanical linkages, e.g., braking, gearing, acceleration, and/or steering. In some embodiments, system 1300 can further include one or more memories or databases. For example, system 1300 can include one or more databases 1308 that store driving rules (e.g., “rules of the road”) and/or a road or terrain map of an area in which the vehicle operates. Alternatively or additionally, one or more databases 1308 can store details regarding one or more trailers to which the vehicle may be coupled, for example, features of gladhand receptacles of the trailers.

In some embodiments, the vehicle sensors 1302 can include a navigation sensor 1302a, an inertial measurement unit (IMU) 1302b, an odometry sensor 1302c, a RADAR system 1302d, an infrared (IR) imager 1302e, a visual camera 1302f, a LIDAR system 1302g, one or more force sensors 1302h, one or more arm assembly sensors 1302i, or any combination thereof. Other sensors are also possible according to one or more contemplated embodiments, such as but not limited to, a pressure sensor that monitors pressure applied via the coupling tool and/or a flow sensor that monitors air flow through the coupling tool, for example, to determine whether the coupling tool has been properly coupled to the gladhand receptacle and/or which coupling tool has been selected from a holder by the robotic arm assembly for connecting to the gladhand receptacle. Alternatively or additionally, sensors 1302 can further include an ultrasonic or acoustic sensor for detecting distance or proximity to objects, a compass to measure heading, inclinometer to measure an inclination of a path traveled by the vehicle (e.g., to assess if the vehicle may be subject to slippage), ranging radios (e.g., as disclosed in U.S. Pat. No. 11,234,201, incorporated herein by reference), lasers and/or optical sensors on the coupling tool to detect a position of the gladhand receptacle and/or alignment therewith, or any combination of the foregoing.

In some embodiments, the navigation sensor 1302a can be used to determine relative or absolute position of the vehicle. For example, the navigation sensor 1302a can comprise one or more global navigation satellite systems (GNSS), such as a global positioning system (GPS) device. In some embodiments, IMU 1302b can be used to determine orientation or position of the vehicle. In some embodiments, the IMU 1302b can comprise one or more gyroscopes or accelerometers, such as a microelectromechanical system (MEMS) gyroscope or MEMS accelerometer.

In some embodiments, the odometry sensor 1302c can detect a change in position of the vehicle over time (e.g., distance). In some embodiments, odometry sensors 1302c can be provided for one, some, or all of wheels of the vehicle, for example, to measure corresponding wheel speed, rotation, and/or revolutions per unit time, which measurements can then be correlated to change in position of the vehicle. For example, the odometry sensor 1302c can include an encoder, a Hall effect sensor measuring speed, or any combination thereof.

In some embodiments, the RADAR system 1302d can use irradiation with radio frequency waves to detect obstacles or features within an environment surrounding the vehicle. In some embodiment, the RADAR system 1302d can be configured to detect a distance, position, and/or movement vector of a feature (e.g., obstacle) within the environment. For example, the RADAR system 1302d can include a transmitter that generates electromagnetic waves (e.g., radio frequency or microwaves), and a receiver that detects electromagnetic waves reflected back from the environment.

In some embodiments, the IR sensor 1302e can detect infrared radiation from an environment surrounding the vehicle. In some embodiments, the IR sensor 1302e can detect obstacles or features in low-light level or dark conditions, for example, by including an IR light source (e.g., IR light-emitting diode (LED)) for illuminating the surrounding environment. Alternatively or additionally, in some embodiments, the IR sensor 1302e can be configured to measure temperature based on detected IR radiation, for example, to assist in classifying a detected feature or obstacle as a person or vehicle.

In some embodiments, the camera sensor 1302f can detect visible light radiation from the environment, for example, to determine features (e.g., obstacles) within the environment and/or features of the trailer (e.g., gladhand receptacle). For example, the camera sensor 1302f can include an imaging sensor array (e.g., a charge-coupled device (CCD) or complementary metal-oxide semiconductor (CMOS) sensor) and associated optical assembly for directing light onto a detection surface of the sensor array (e.g., lenses, filters, mirrors, etc.). In some embodiments, multiple camera sensors 1302f can be provided in a stereo configuration, for example, to provide depth measurements.

In some embodiments, the LIDAR sensor system 1302g can include an illumination light source (e.g., laser or laser diode), an optical assembly for directing light to/from the system (e.g., one or more static or moving mirrors (such as a rotating mirror), phased arrays, lens, filters, etc.), and a photodetector (e.g., a solid-state photodiode or photomultiplier). In some embodiments, the LIDAR sensor system 1302g can use laser illumination to measure distances to obstacles or features within an environment surrounding the trailer. In some embodiments, the LIDAR sensor system 1302g can be configured with a field-of-view primarily directed to detect features at the rear and/or sides of the trailer. Alternatively or additionally, in some embodiments, the LIDAR sensor system 1302g can be used to identify the loading dock and/or measure features thereof. Alternatively or additionally, in some embodiments, the LIDAR sensor system 1302g can be configured to provide three-dimensional imaging data of the environment, and the imaging data can be processed (e.g., by the LIDAR system itself or by a module of control system 1306) to generate a view of the environment (e.g., at least a 180-degree view, a 270-degree view, or a 360-degree view).

In some embodiments, the force sensor 1302h can measure forces applied to the robotic arm assembly 1316 and/or a coupling tool 1310, for example, to measure a clamping force applied by the coupling tool 1310 to the corresponding gladhand receptacle. In some embodiments, the force sensor 1302h can comprise a strain gauge, a piezoelectric sensor, a capacitive sensor, an inductive sensor, a load cell, or any combination thereof. In some embodiments, the arm sensor 1302i can measure characteristics of the robotic arm assembly 1316 and/or coupling tool 1310, for example, a position of a telescoping arm and/or displacement of linear actuators. In some embodiments, arm sensor 1302i can comprise a linear encoder, a rotary encoder, or any combination thereof. Alternatively or additionally, in some embodiments, the arm sensor 1302i can measure location of the gladhand receptacle with respect to the end effector, for example, to assist in alignment between the end effector and the gladhand receptacle. For example, the arm sensor 1302i can include an optical detector to image the pneumatic port and/or sealing member of the gladhand receptacle, and optionally part of the end effector that interfaces with the pneumatic port and/or sealing member.

The vehicle sensors 1302 can be operatively coupled to the control system 1306, such that the control system 1306 can receive data signals from the sensors 1302 and control operation of the vehicle (e.g., vehicle 202), or components thereof (e.g., drive-by-wire system 1318, communication unit 1304, coupling tool 1310, tool library 1312, manifold 1314, robotic arm assembly 1316, and/or end-of-arm tool 1320), responsively thereto. For example, FIG. 9 shows a configuration of a control system 1306 that includes, in accordance with some embodiments, one or more modules, programs, software engines or processor instructions for performing at least some of the functionalities described herein. For example, control system 1306 may comprise one or more software module(s) or engine(s) for directing one or more processors of system 1300 to perform certain functions. In some embodiments, software components, applications, routines, or sub-routines, or sets of instructions for causing one or more processors to perform certain functions may be referred to as “modules” or “engines.” It should be noted that such modules or engines, or any software or computer program referred to herein, may be written in any computer language and may be a portion of a monolithic code base, or may be developed in more discrete code portions, such as is typical in object-oriented computer languages. In addition, the modules or engines, or any software or computer program referred to herein, may in some embodiments be distributed across a plurality of computer platforms, servers, terminals, and the like. For example, a given module or engine may be implemented such that the described functions are performed by separate processors and/or computing hardware platforms. Further, although certain functionality may be described as being performed by a particular module or engine, such description should not be taken in a limiting fashion. In other embodiments, functionality described herein as being performed by a particular module or engine may instead (or additionally) be performed by a different module, engine, program, sub-routine, or computing device without departing from the spirit and scope of the invention(s) described herein.

It should be understood that any of the software modules, engines, or computer programs illustrated herein may be part of a single program or integrated into various programs for controlling one or more processors of a computing device or system. Further, any of the software modules, engines, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software modules, engines, or computer programs may be included, and it should be understood that the examples illustrated and described with respect to FIG. 9 are not necessary in any embodiments. Use of the terms “module” or “software engine” is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for ease or convenience of description only and such functionality may in fact be a part of, or integrated into, another module, engine, program, application, or set of instructions for directing a processor of a computing device.

In some embodiments, the instructions of any or all of the software modules, engines or programs described above may be read into a main memory from another computer-readable medium, such from a read-only memory (ROM) to random access memory (RAM). Execution of sequences of instructions in the software module(s) or program(s) can cause one or more processors to perform at least some of the processes or functionalities described herein. Alternatively or additionally, in some embodiments, hard-wired circuitry may be used in place of, or in combination with, software instructions for implementation of the processes or functionalities described herein. Thus, the embodiments described herein are not limited to any specific combination of hardware and software.

In the illustrated example of FIG. 9, the control system 1306 includes a receptacle identification module 1306a, an arm path planning module 1306b, and a pneumatic pressure control module 1306c. In some embodiments, the receptacle identification module 1306a can be configured to automatically identify features of a gladhand receptacle for coupling thereto. For example, the receptacle identification module 1306a can identify the type of the gladhand receptacle (e.g., for selecting an appropriate coupling tool configuration and/or coupling tool), identify a location of the gladhand receptacle (e.g., a location of the pneumatic port and/or sealing member), and/or determine an orientation of the gladhand receptacle (e.g., stowed position and/or deviation from a standard coupling orientation). In some embodiments, the receptacle identification module 1306a can identify a gripping portion of the gladhand receptacle, for example, lug 130 (or detent plate). In some embodiments, the receptacle identification module 1306a can further determine a distance between an identified vertical feature (e.g., hinge or joint) and a portion of the gladhand receptacle.

In some embodiments, the arm path planning module 1306b can plan a path for the coupling tool and/or the robotic arm assembly connected thereto. The arm path planning module 1306b can plan a path from an initial position proximal to the rear of the vehicle (e.g., with robotic arm assembly holding the coupling tool) to a final coupling position, where an outlet of the coupling tool is aligned with the pneumatic port of the gladhand receptacle. Alternatively or additionally, in some embodiments, the path can be planned from a coupling tool selection position (e.g., via tool library 1312) to the final coupling position. Alternatively or additionally, the path can be planned from an initial stowed position of the robotic arm assembly to a coupling tool selection position and then on to the final coupling position. Alternatively or additionally, the path can be planned by module 1306b for the coupling tool (and/or the robotic arm assembly connected thereto) to rotate the gladhand receptacle to a coupling position, for example, via the means for grasping and/or actuating. In some embodiments, the arm path planning module 1306b can plan a return path of the robotic arm assembly without the coupling tool (e.g., after the coupling tool has been successfully coupled to the receptacle and thus released from the arm assembly), for example, to a stowed position. In some embodiments, the planning can be such that the path avoids moving or stationary obstacles. In some embodiments, the arm path planning module 1306b can control the robotic arm assembly 1316 to follow the planned path, and/or the vehicle control system 1306 can control the coupling tool 1310 to rotate and/or engage the gladhand receptacle. Alternatively or additionally, the arm path planning module 1306b can control the robotic arm assembly 1316 to follow the planned path, the vehicle control system 1306 can control the end-of-arm tool 1320 to fully or partially rotate the gladhand receptacle, and/or the vehicle control system 1306 can control the coupling tool 1310 to engage the rotated gladhand receptacle.

In some embodiments, the pneumatic pressure control module 1306c can control manifold 1314 (e.g., comprising one or more valves) to direct pressurized air from a pneumatic source to coupling tool 1310. For example, the pneumatic pressure control module 1306c can route pressurized air to the appropriate coupling tool 1310 based at least in part on the location that the robotic arm assembly 1316 picked up the coupling tool 1310 from the tool library 1312, the location of gladhand receptacle coupled to the coupling tool 1310, and/or sensing at the coupling tool 1310.

In some embodiments, the control system 1306 can also include a vehicle path planning module 1306d, an obstacle detection module 1306e, and/or a drive control module 1306f. Other modules or components are also possible according to one or more contemplated embodiments. In some embodiments, the vehicle path planning module 1306d can be configured to plan a route for the vehicle to follow. In some embodiments, the vehicle path planning module 1306d can employ data stored in database 1308 regarding rules of the road and/or the road network or area to plan a route while avoiding known or detected obstacles in the environment. In some embodiments, the control system 1306 can use signals from the sensors 1302 to identify traversable paths through the area, for example, using vehicle position and/or features identified in the surrounding environment by one or more of sensors 1302. In some embodiments, drive control module 1306f can then control the drive-by-wire system 1318 (e.g., an electrical or electro-mechanical system that controls steering, gearing, velocity, acceleration, and/or braking) to have the vehicle (e.g., with trailer coupled thereto) follow the planned route. Alternatively or additionally, in some embodiments, the control system 1306 can control the drive-by-wire system 1318 based one or more signals received via communication unit 1314 (e.g., transceiver for wireless communication), for example, to follow another vehicle (e.g., autonomous or manually-operated leader vehicle). In some embodiments, the obstacle detection module 1306e can be configured to detect obstacles (e.g., impassable road features, other vehicles, pedestrians, etc.) as the vehicle moves. Control system 1306 can be further configured to avoid the detected obstacles, for example, by instructing the vehicle to follow a deviation from the planned path and/or an alternative path.

In some embodiments, the vehicle can communicate with other vehicles and/or a communication infrastructure (e.g., cellular network) via communication unit 1304. Alternatively or additionally, the communication unit 1304 can communicate instructions to and/or receive signals from an end effector coupled to the gladhand receptacle of the trailer, for example, to control coupling operation thereof. In some embodiments, the communication unit employs a wireless communication modality, such as radio, ultra-wideband (UWB), Bluetooth, Wi-Fi, cellular, optical, or any other wireless communication modality.

### VIII. Computer Implementation

FIG. 10 depicts a generalized example of a suitable computing environment 1430 in which the described innovations may be implemented, such as aspects of control system 204, controller 514, controller 536, control system 816, vehicle control system 1306, etc. The computing environment 1430 is not intended to suggest any limitation as to scope of use or functionality, as innovations may be implemented in diverse general-purpose or special-purpose computing systems. For example, computing environment 1430 can be any of a variety of computing devices (e.g., desktop computer, laptop computer, server computer, tablet computer, etc.).

In the illustrated example, the computing environment 1430 includes one or more processing units 1434, 1436 and one or more memories 1438, 1440, with base configuration 1450 included within a dashed line. The processing units 1434, 1436 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 10 shows a central processing unit 1434 as well as a graphics processing unit or co-processing unit 1436. The tangible memory 1438, 1440 may be volatile memory (e.g., registers, cache, RAM), non-volatile memory (e.g., ROM, EEPROM, flash memory, etc.), or some combination of the two, accessible by the processing unit(s). The memory 1438, 1440 stores software 1432 implementing one or more innovations described herein, in the form of computer-executable instructions suitable for execution by the processing unit(s).

A computing system may have additional features. For example, the computing environment 1430 includes one or more storage 1460, one or more input devices 1470, one or more output devices 1480, and one or more communication connections 1490. An interconnection mechanism (not shown) such as a bus, controller, or network interconnects the components of the computing environment 1430. In some embodiments, an operating system software (not shown) can provide an operating environment for other software executing in the computing environment 1430 and can coordinate activities of the components of the computing environment 1430.

The tangible storage 1460 may be removable or non-removable, and includes magnetic disks, magnetic tapes or cassettes, CD-ROMs, DVDs, or any other medium which can be used to store information in a non-transitory way, and which can be accessed within the computing environment 1430. The storage 1460 can store instructions for the software 1432 implementing one or more innovations described herein.

The input device(s) 1470 may be a touch input device such as a keyboard, mouse, pen, or trackball, a voice input device, a scanning device, or another device that provides input to the computing environment 1430. The output device(s) 1470 may be a display, printer, speaker, CD-writer, or another device that provides output from computing environment 1430.

The communication connection(s) 1490 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Python, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### IX. Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication.” As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required. Although a product may be described as including a plurality of components, aspects, qualities, characteristics, and/or features, that does not indicate that all of the plurality are essential or required. Various other embodiments within the scope of the described invention(s) include other products that omit some or all of the described plurality. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The term “product” means any machine, manufacture, and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A reference to “another embodiment” in describing an embodiment does not imply that the referenced embodiment is mutually exclusive with another embodiment (e.g., an embodiment described before the referenced embodiment), unless expressly specified otherwise.

The indefinite articles “a” and “an,” as used herein in the specification and in the claims, unless clearly indicated to the contrary, should be understood to mean “at least one” or “one or more”.

The phrase “and/or” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car, and a wheel.

The phrase “based on” does not mean “based only on”, unless expressly specified otherwise. In other words, the phrase “based on” describes both “based only on” and “based at least on”.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same. Similarly, while the terms “horizontal” and “vertical” may be utilized herein, such terms may refer to any normal geometric planes regardless of their orientation with respect to true horizontal or vertical directions (e.g., with respect to the vector of gravitational acceleration).

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™M, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Embodiments of the disclosed subject matter can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### X. Conclusion

Although particular vehicles, trailers, sensors, components, and configuration have been illustrated in the figures and discussed in detail herein, embodiments of the disclosed subject matter are not limited thereto. Indeed, one of ordinary skill in the art will readily appreciate that different vehicles (e.g., any vehicle where gladhand connections are used), trailers (e.g., tanker trailers, flat-bed trailer, reefer trailer, box trailer, etc.), sensors, components, or configurations can be selected and/or components added to achieve the same effect. In practical implementations, embodiments may include additional components or other variations beyond those illustrated. Accordingly, embodiments of the disclosed subject matter are not limited to the particular vehicles, trailers, sensors, components, and configurations specifically illustrated and described herein.

Any of the features illustrated or described with respect to one of FIGS. 1A-10 (or otherwise disclosed herein) and/or FIGS. 1A-14 and Clauses 1-69 of U.S. Pat. No. 11,999,206 (or otherwise disclosed therein) can be combined with features illustrated or described with respect to any other of FIGS. 1A-10 (or otherwise disclosed herein) and/or FIGS. 1A-14 and Clauses 1-69 of U.S. Pat. No. 11,999,206 (or otherwise disclosed therein) to provide systems, methods, devices, and embodiments not otherwise illustrated or specifically described herein. All features described herein are independent of one another and, except where structurally impossible, can be used in combination with any other feature described herein.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereof, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Various modifications of the invention and many further embodiments thereof, in addition to those shown and described herein, will become apparent to those skilled in the art from the full contents of this document, included references to the scientific and patent literature cited herein. The subject matter herein contains information, exemplification, and guidance that can be adapted to the practice of this invention in its various embodiments and equivalents thereof.

1. A system comprising:
(a) a vehicle comprising a pneumatic source of pressurized air;
(b) a robotic arm assembly supported on or coupled to the vehicle;
(c) a gladhand coupling tool releasably connected to the robotic arm assembly and configured to connect to a gladhand receptacle of a trailer; and
(d) an air supply line coupled to the gladhand coupling tool, the air supply line being configured to deliver pressurized air from the pneumatic source to a braking system of the trailer when the gladhand coupling tool is connected to the gladhand receptacle of the trailer,
wherein the gladhand receptacle is rotatable between a first position and a second position,
in the first position, the gladhand receptacle has an orientation with respect to a front surface of the trailer, such that a pneumatic port of the gladhand receptacle faces the front surface,
in the second position, the gladhand receptacle has a different orientation with respect to the front surface, such that the pneumatic port is exposed, and
one of the gladhand coupling tool and the robotic arm assembly includes a rotation member constructed to interface with a portion of the gladhand receptacle so as to rotate the gladhand receptacle from the first position to the second position in preparation for connecting the gladhand coupling tool to the gladhand receptacle.

2. The system of claim 1, wherein the portion of the gladhand receptacle is a lug or detent plate.

3. The system of claim 1, wherein the gladhand coupling tool includes the rotation member, and the rotation member is constructed to remain with the portion of the gladhand receptacle after the gladhand coupling tool is connected to the gladhand receptacle and released from the robotic arm assembly.

4. The system of claim 1, wherein the robotic arm assembly includes the rotation member, and the rotation member is constructed to remain with the robotic arm assembly after the gladhand coupling tool is connected to the gladhand receptacle and released from the robotic arm assembly.

5. The system of claim 1, further comprising:
one or more sensors mounted on the vehicle and configured to detect features in an environment surrounding the vehicle; and
a control system operatively coupled to the one or more sensors and the robotic arm assembly, the control system comprising one or more processors and one or more non-transitory computer-readable media storing computer-readable instructions that, when executed by the one or more processors, cause the one or more processors to:
identify, based at least in part on one or more signals from the one or more sensors, the gladhand receptacle in the first position, a pivot or hinge of the gladhand receptacle, and the portion of the gladhand receptacle;
plan a path so as to position the rotation member proximal to the portion of the gladhand receptacle;
move, via the robotic arm assembly, the gladhand coupling tool along the planned path;
move the rotation member to engage with the portion of the gladhand receptacle;
reposition, via movement of the robotic arm assembly, the gladhand receptacle from the first position to the second position; and
actuate the gladhand coupling tool to connect to the gladhand receptacle such that a sealed air flow path is established between the air supply line and the trailer braking system.

6. The system of claim 5, wherein the one or more non-transitory computer-readable media store additional computer-readable instructions that, when executed by the one or more processors, further cause the one or more processors to disconnect the gladhand coupling tool from the robotic arm assembly.

7. The system of claim 6, wherein the one or more non-transitory computer-readable media store additional computer-readable instructions that, when executed by the one or more processors, further cause the one or more processors to move the robotic arm assembly to a stowed position remote from the trailer after disconnecting the gladhand coupling tool.

8. The system of claim 5, wherein:
the vehicle comprises a drive-by-wire kit and one or more motors; and
the one or more non-transitory computer-readable media store further instructions that, when executed by the one or more processors, cause the one or more processors to autonomously operate the vehicle via the drive-by-wire kit and the one or motors.

9. The system of claim 1, further comprising one or more additional coupling tools configured to be releasably connected to the robotic arm assembly.

10. The system of claim 9, wherein the vehicle comprises a library or holder, and the one or more additional coupling tools are stored in or supported by the library or holder.

11. The system of claim 9, wherein:
the vehicle comprises one or more faux gladhand receptacles, and the one or more additional coupling tools are supported on the one or more faux gladhand receptacles, respectively; or
the vehicle comprises a holder, the gladhand coupling tool and/or the one or more additional coupling tools being configured to releasably connect to the holder via mechanical and/or magnetic means.

12. The system of claim 9, wherein the one or more additional coupling tools includes another gladhand coupling tool for connecting to another gladhand receptacle of the trailer, an electrical coupling tool for connecting to an electrical service line of the trailer, or any combination of the foregoing.

13. The system of claim 1, wherein the gladhand coupling tool comprises at least one of an electric motor, a hydraulic actuator, a hydraulic supply line, a pneumatic actuator, a pneumatic supply line, a spring, or any combination of the foregoing configured to supply a clamping force between first and second parts of the gladhand coupling portion.

14. The system of claim 1, wherein the gladhand coupling tool has a first coupling face, the robotic arm assembly comprises a tool mating interface, and the gladhand coupling tool is releasably connected to the robotic arm assembly via contact between the first coupling face and the tool mating interface.

15. The system of claim 14, wherein at least one of the first coupling face and the tool mating interface comprises a permanent magnet, an electromagnet, servo lock, or any combination of the foregoing configured to retain the gladhand coupling tool to the robotic arm assembly.

16. The system of claim 15, wherein the gladhand coupling tool is retained to the robotic arm assembly by magnetic attraction between the first coupling face and tool mating interface.

17. The system of claim 1, wherein the gladhand coupling tool, the robotic arm assembly, and/or the vehicle comprises at least one sensor configured to detect the gladhand receptacle and/or positioning of the gladhand coupling tool with respect to the gladhand receptacle.

18. The system of claim 17, wherein the at least one sensor comprises an optical camera, an infrared imager, a light detection and ranging (LIDAR) system, a radio detection and ranging (RADAR) system, an acoustic sensor, an ultrasonic sensor, or any combination of the foregoing.

19. The system of claim 1, wherein the rotation member is rotatably mounted to said one of the gladhand coupling tool and the robotic arm assembly.

20. The system of claim 19, wherein the rotation member is mounted to said one of the gladhand coupling tool and the robotic arm assembly via one or more springs.

21. The system of claim 1, wherein the rotation member comprise a loop of fixed length, a loop of actively-adjustable length, a loop of passively-adjustable length, a flat plate or spatula-like feature, or a hook or other open feature.

22. The system of claim 1, wherein the rotation member or a portion thereof is formed of one or more metallic or non-metallic filaments.

23. The system of claim 1, wherein the rotation member or a portion thereof is formed of an active shape control material.

24. The system of claim 23, wherein the active shape control material comprises an internal tensile member, an internal compressive member, a pneumatically-actuatable member, a hydraulically-actuatable member, a shape memory alloy, or any combination of the foregoing.

25. The system of claim 1, wherein the rotation member is configured to elongate, contract, rotate, and/or otherwise actuate, in response to thermal input, electrical input, ionic input, magnetic input, or any combination of the foregoing.

26. The system of claim 1, wherein the robotic arm assembly is further configured to couple an electrical connector to a battery charging receptacle of the vehicle.

27. The system of claim 1, wherein the gladhand coupling tool comprises an alignment member constructed to abut the portion of the gladhand receptacle so as to assist in aligning the gladhand coupling tool to the gladhand receptacle during connection and/or to restrain the gladhand coupling tool from rotating due to gravity when connected to the gladhand receptacle.
